(19) United States
(12) Patent Application Publication
(10) Pub. No.: US 2019/0043499 A1
(43) Pub. Date: Feb. 7, 2019

(54) VOICE CONTROL DEVICE AND ASSOCIATED VOICE SIGNAL PROCESSING METHOD

(71) Applicant: MStar Semiconductor, Inc., Hsinchu Hsien (TW)

(72) Inventors: Jung-Kuei Chang, Hsinchu County (TW); Huang-Hsiang Lin, Hsinchu County (TW); Chen-Yu Lee, Hsinchu County (TW)

(21) Appl. No.: 15/995,601

(22) Filed: Jun. 1, 2018

Related U.S. Application Data
(60) Provisional application No. 62/540,584, filed on Aug. 3, 2017.

(51) Int. Cl. G10L 15/22; G06F 12/14; G10L 15/28; H04N 21/422

(52) U.S. Cl. CPC G10L 15/22; G06F 12/1458; G10L 2015/088; H04N 21/42203; G10L 2015/223; G10L 15/285

(57) ABSTRACT

A voice control device includes a receiving circuit, a voice processing circuit, a memory controller and a main processing circuit. The receiving circuit sequentially receives first voice data and second voice data, and stores the same in a first memory. The voice processing circuit reads the first voice data from the first memory, and generates a control signal when the first voice data includes a predetermined command. The memory controller reads the second voice data from the first memory according to the control signal, and stores the second voice data in a second memory. The main processing circuit reads the second voice data from the second memory according to the control signal so as to perform voice recognition.

This application claims the benefit of U.S. Provisional Application Ser. 62/540,584, filed Aug. 3, 2017, the subject matter of which is incorporated herein by reference.

### BACKGROUND OF THE INVENTION

### Field of the Invention

The invention relates to a voice control device, and more particularly to a voice control device provided in a television or a set-top box (STB).

### Description of the Related Art

In a current voice control device, in order to recognize voice messages at all times, a processor, a memory and associated circuits in the voice device are constantly in an enabled state and cannot enter a hibernation mode, resulting in high power consumption even when the voice control device is not under actual use.

### SUMMARY OF THE INVENTION

The present invention discloses a voice control device and an associated voice signal processing method which allow some circuits in the voice control device to enter a hibernation state so as to achieve power saving. However, the voice control device can still be woken up by a predetermined voice command of a user and then start performing voice recognition, hence solving issues of the prior art.

A voice control device is disclosed according to an embodiment of the present invention. The voice control device includes a receiving circuit, a voice processing circuit, a memory control circuit and a main processing circuit. In an operation of the voice control device, the receiving circuit sequentially receives first voice data and second voice data, and stores the same in a first memory. The voice processing circuit reads the first voice data from the first memory, and generates a control signal when the first voice data includes a predetermined command. The memory control circuit reads the second voice data from the first memory, and stores the read second data in a second memory. The main processing circuit reads the second data from the second memory according to the control signal to perform voice recognition.

A voice signal processing method is disclosed according to another embodiment of the present invention. The method includes: sequentially receiving first voice data and second voice data, and storing the same in a first memory; reading the first voice data from the first memory, and generating a control signal when the first voice data includes a predetermined command; reading the second voice data from the first memory according to the control signal and storing the read second voice data in a second memory; and reading the second voice data from the second memory according to the control signal to perform voice recognition.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of a voice control device according to an embodiment of the present invention;

FIG. 2 is a timing diagram of a voice control device receiving voice data and some elements according to an embodiment of the present invention;

FIG. 3 is a flowchart of a voice signal processing method according to an embodiment of the present invention; and

FIG. 4 is a block diagram of a voice control device according to another embodiment of the present invention.

### DETAILED DESCRIPTION OF THE INVENTION

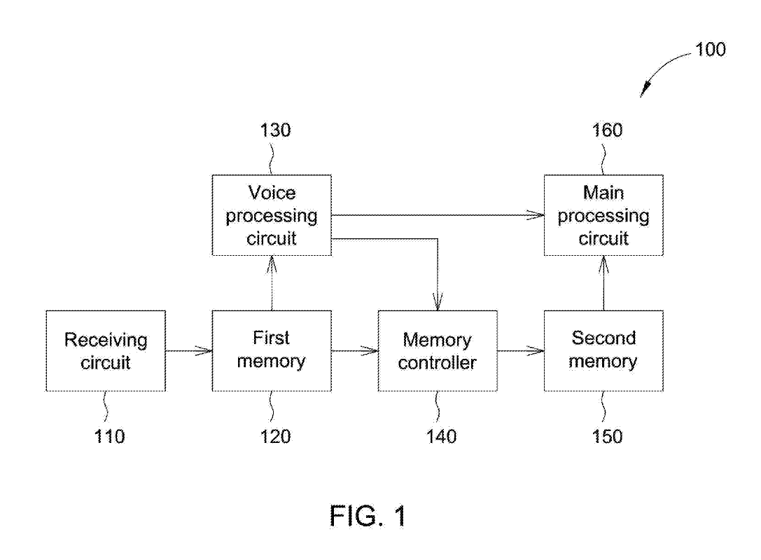

FIG. 1 shows a block diagram of a voice control device 100 according to an embodiment of the present invention. As shown in FIG. 1, the voice control device 100 includes a receiving circuit 110, a first memory 120, a voice processing circuit 130, a memory controller 140, a second memory 150 and a main processing circuit 160. In this embodiment, the first memory 110 and the second memory 150 may be a static random access memory (SRAM) and a dynamic random access memory (DRAM), respectively; other elements apart from the second memory 150 may be provided in a chip. Further, the voice control device 100 is provided in a television or in a set-top box (STB) to receive voice data and then perform voice recognition, so as to accordingly control the operation of the television.

In some embodiments, the receiving circuit 110 may include a digital microphone and a converting circuit. The digital microphone converts a received voice signal to a pulse density modulation (PDM) signal, and converts and encodes the PDM signal to a pulse-code modulation (PCM) signal. The receiving circuit 110 may also include an analog microphone and a converting circuit. The analog microphone receives a voice signal, and the converting circuit converts and encodes the voice signal to a PCM signal. The converting circuit may be an analog-to-digital conversion (ADC) circuit, an analog-to-digital conversion-to-inter-integrated-circuit (ADC-to-I²C) circuit, or an analog-to-digital conversion-to-inter-integrated-circuit time-division multiplexing (ADC-to-I²C TDM) circuit.

In the voice control device 100 disclosed by the present invention, the receiving circuit 110, the first memory 120 and the voice processing circuit 130 are constantly in an enabled state to readily detect at all times whether an event needing voice recognition has occurred. The memory controller 140, the second memory 150 and the main processing circuit 160 are allowed to enter a hibernation state when idle so as to save power consumption (e.g., the second memory 150 may be in a suspend-to-RAM (STR)) mode. More specifically, when the voice control device 100 does not receive any valid voice messages within a period of time, the memory controller 140, the second memory 150 and the main processing circuit 160 may enter a hibernation state (e.g., disconnected from power or be supplied with extremely low power) so as to save power. When the receiving circuit 110, the first memory 120 and the voice processing circuit 130 receive voice data having a predetermined command, a wakeup signal is accordingly generated to again enable the memory controller 140, the second memory 150 and the main processing circuit 160, and a control signal is generated and sent to the memory controller 140 and the main processing circuit 160 to perform voice recognition on subsequent voice data. In this embodiment, the control signal and the wakeup signal are the same signal, and is exemplified by a control signal in the description below.

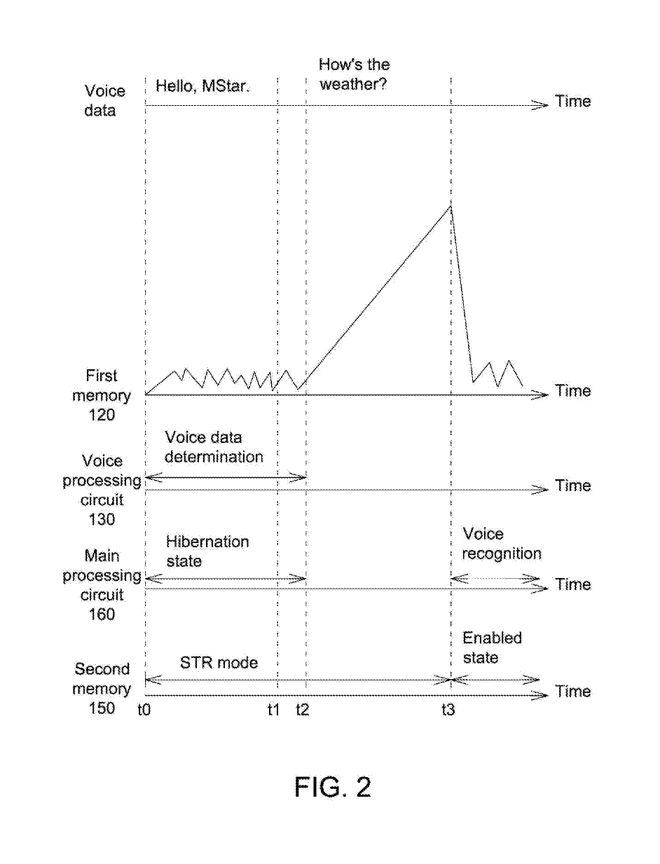

More specifically, referring to FIG. 1 and FIG. 2, FIG. 2 shows a timing diagram of the voice control device 100 receiving voice data and some of the elements. Assume that at a time point t0, the memory controller 140, the second memory 150 and the main processing circuit 160 are in a hibernation state. At this point, a user wishes to enquire current weather conditions, and speaks a sentence “Hello, MStar. How's the weather?”, wherein “Hello, MStar.” serves as a predetermined command for activating the voice recognition of the voice control device 100. While the user speaks “Hello, MStar.”, the receiving circuit 110 sequentially stores the received voice data in the first memory 120, and the voice processing circuit 130 reads the voice data from the first memory 120 according to a reading trigger mechanism. The reading trigger mechanism may be the amount of valid data stored in the first memory 120 having reached a threshold, or after a predetermined time interval, or the first memory 120 has received a complete set of packet data. It should be noted that, “valid data” refers to unprocessed and non-deletable voice data but not non-deleted data that is still stored in the memory 120. In FIG. 2, the change in the amount of valid data stored in the first memory 120 can be observed. Voice data is constantly written in the first memory 120 (i.e., the amount of valid data stored increases) and the voice data is constantly being read by the voice processing circuit 130 (i.e., the amount of valid data stored decreases), such that the amount of valid data stored is maintained at a low level.

At a time point t1, assume that the sentence “Hello, MStar.” spoken by the user has been sequentially stored in the first memory 120. The voice processing circuit 130 reads the voice data from the first memory 120, and determines, at a time point t2, that the voice data previously stored in the first memory 120 includes the predetermined command “Hello, MStar.” for activating the voice recognition function of the voice control device 100. In response, the voice processing circuit 130 generates the control signal to wake up the memory controller 140 and the main processing circuit 160.

At the time point t2, the memory controller 140 and the main processing circuit 160 start performing a pre-operation before the normal operation, and the voice processing circuit 130 no longer reads the voice data from the first memory 120. However, the voice data, e.g., “How's the weather?” in this embodiment, received by the receiving circuit 110 is continually written in the first memory 120. Thus, in FIG. 2, it is seen that, starting from the time point t2, the amount of valid data stored in the memory 120 is continually increased to a higher level.

After the memory controller 140 and the main processing circuit 160 have completed the pre-operation (e.g., at a time point t3 in FIG. 2), the voice processing circuit 130 controls the memory controller 140 to read the temporarily stored valid data (e.g., the voice data “How's weather?”) from the first memory 120, and stores the same in the second memory 150 in an enabled state, and the main processing circuit 160 reads the foregoing temporarily stored valid data from the second memory 150 to perform voice recognition. Because the foregoing temporarily stored valid data is transferred from the first memory 120 to the second memory 150, it is seen in FIG. 2 that, starting from the time point t3, the amount of valid data stored in the first memory 120 returns to the lower level.

In the embodiment shown in FIG. 1 and FIG. 2, when the voice device 100 is in an idle state, only the receiving circuit 110, the first memory 120 and the voice processing circuit 130 need to be in an enabled state, and the voice processing circuit 130 is designed to be able to recognize only the voice data of the predetermined command “Hello, MStar.”. Therefore, these elements needing to be in an enabled state over an extended period of time require minimal power consumption. In contrast, the elements requiring more power consumption, e.g., the main processing circuit 160, can enter a hibernation state when idle, thus significantly reducing power consumption.

After the temporarily stored valid data in the first memory 120 is transferred to the second memory 150, the voice recognition in the voice control device 100 is handed over to the main processing circuit 160, and the voice processing circuit 130 no longer reads the voice data from the first memory 120. Therefore, in the embodiment in FIG. 1 and FIG. 2, the voice processing circuit 130 may be switched to a hibernation state (e.g., power is disconnected or an extremely low power is supplied) to further save power, and is again woken up after the main processing circuit 160 again enters hibernation. In another embodiment, because the voice processing circuit 130 is a low power consuming element, it can be selectively designed to remain in an enabled state.

Further, in the embodiment in FIG. 1 and FIG. 2, after the valid data temporarily stored in the first memory 120 is transferred to the second memory 150, the receiving circuit 110 continually stores the voice data in the first memory 120, and the memory controller 140 continually transfers the voice data from the first memory 120 to the second memory 150. However, in another embodiment, after the valid data temporarily stored in the first memory 120 is transferred to the second memory 150, the receiving circuit 110 may be switched to directly store the voice data subsequently received in the second memory 150.

In one embodiment, the above “Hello, MStar.” may be regarded as a first predetermined command, and the voice processing circuit 130 may further determine, according to whether the voice data includes a second predetermined command, which database the main processing circuit 160 is to use to perform recognition on the subsequent voice data. More specifically, if the voice signal further includes “OK, Google.”, the voice processing circuit 130 generates a control signal to the main processing circuit 160 so as to perform voice recognition via the Internet by using the Google database. If the voice signal further includes “OK, Alexa.”, the voice processing circuit 130 generates a control signal to the main processing circuit 160 so as to perform voice recognition via the Internet by using the Amazon database. Further, an element in the main processing circuit 160 that uses different databases to perform voice recognition may be the same or different hardware.

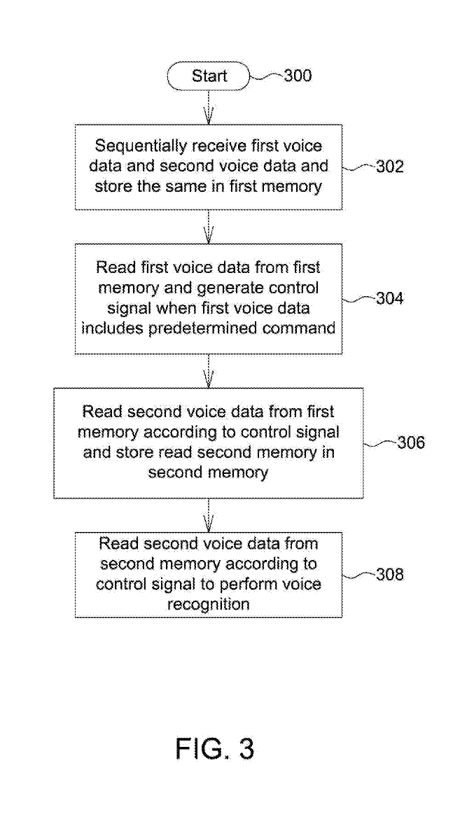

FIG. 3 shows a flowchart of a voice signal processing method according to an embodiment of the present invention. Referring to the disclosure of the embodiment in FIG. 1 and FIG. 2, the process of FIG. 3 includes following steps.

In step 300, the process begins.

In step 302, first voice data and second voice data are sequentially received and stored in a first memory.

In step 304, the first voice data is read from the first memory, and a control signal is generated when the first voice data includes a predetermined command.

In step 306, the second voice data is read from the first memory according to the control signal, and the read second voice data is stored in a second memory.

In step 308, the second voice data is read from the second memory according to the control signal to perform voice recognition.

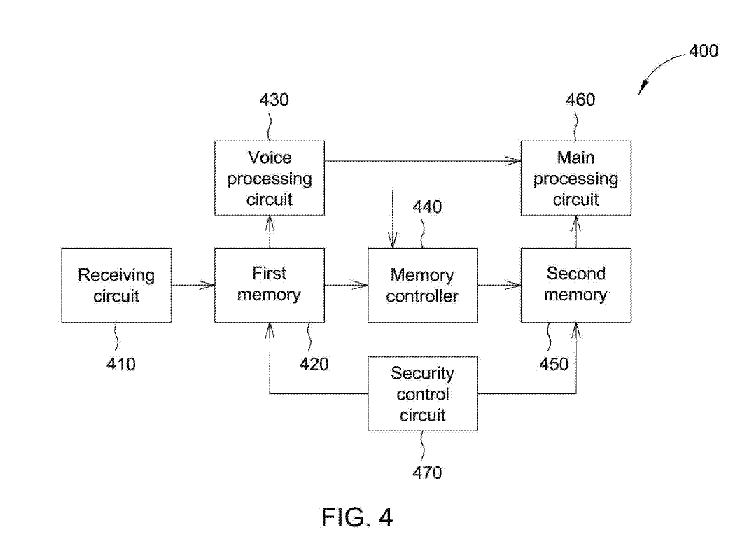

FIG. 4 shows a block diagram of a voice control device 400 according to another embodiment of the present invention. As shown in FIG. 4, the voice control device 400 includes a receiving circuit 410, a first memory 420, a voice processing circuit 430, a memory controller 440, a second memory 450, a main processing circuit 460 and a security control circuit 470. The difference of the embodiment in FIG. 4 from the voice control device 100 in FIG. 1 is the additional security control circuit 470. Details in regard to only the security control circuit 470 are given below.

In the voice control device 400, the security control circuit 470 sets access permission of the first memory 420 and/or the second memory 450, so as to prevent theft of the voice data stored in the first memory 420 and/or the second memory 450. More specifically, the security control circuit 470 may set a part of the first memory 420 as a security protection area, and the receiving circuit 410 stores the received voice data in the security protection area, which is permitted to be accessed by the voice processing circuit 430 and the memory controller 440 for reading and writing operations. Similarly, the security control circuit 470 may also set a part of the second memory 450 as a security protection area, and the memory controller 440 stores the voice data from the first memory 420 to the security protection area, which is permitted to be accessed only by the main processing circuit 460 for reading and writing operations. Because the receiving circuit 410 is constantly operating, it continually receives ambient voices and stores the same in the first memory 420 and/or the second memory 450. Through the security control circuit 470, the voice data in the first memory 420 or the second memory 450 may be prevented from theft, preventing the voice device from becoming an eavesdropping channel of individuals with ill intention.

In summary, in the voice control device and the associated voice signal processing method of the present invention, elements with higher power consumption can be deactivated when the voice control device is in a hibernation state, and some elements with extremely low power consumption can be maintained activated to determine whether the voice data includes a predetermined command. Therefore, the voice control device can be woken up from a power-saving state according to a predetermined command of a user to start performing voice recognition, satisfying both environmental friendliness and user convenience.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A voice control device, comprising:
a receiving circuit, sequentially receiving first voice data and second voice data, and storing the same in a first memory;
a voice processing circuit, reading the first voice data from the first memory, and generating a control signal when the first voice data comprises a predetermined command;
a memory control circuit, reading the second voice data from the first memory according to the control signal, and storing the read second voice data in a second memory; and
a main processing circuit, reading the second voice data from the second memory according to the control signal to perform voice recognition.

2. The voice control device according to claim 1, wherein the voice control device is provided in a television or in a set-top box (STB).

3. The voice control device according to claim 1, wherein the predetermined command is a first predetermined command, the control signal is a first control signal, and the voice processing circuit generates a second control signal to the memory control circuit and the main processing circuit when the first voice data comprises a second predetermined command.

4. The voice control device according to claim 1, wherein when the voice control device is in an idle state, the memory control circuit and the main processing circuit are in a hibernation state and the receiving circuit and the voice processing circuit are in an enabled state; when the voice control device is in the idle state and the voice processing circuit determines that the first voice data comprises the predetermined command, the voice processing circuit generates a wakeup signal to wake up the memory control circuit and the main processing circuit.

5. The voice control device according to claim 4, wherein after the voice processing circuit generates the wakeup signal to wake up the memory control circuit and the main processing circuit, the voice processing circuit does not read the second voice data from the first memory.

6. The voice control device according to claim 4, wherein after the voice processing circuit generates the wakeup signal to wake up the memory control circuit and the main processing circuit, the voice processing circuit generates the control signal to control the memory control circuit to transfer the second voice data in the first memory to the second memory.

7. The voice control device according to claim 1, further comprising:
a security control circuit, setting access permission of at least one of the first memory and the second memory.

8. The voice control device according to claim 7, wherein the security control circuit sets an area in the first memory as a security area, the receiving circuit stores the first voice data and the second voice data in the security area, and the security area is permitted to be accessed only by the voice processing circuit and the memory control circuit for reading and writing operations.

9. The voice control device according to claim 7, wherein the security control circuit sets an area in the second memory as a security area, and the security area is permitted to be accessed only by the main processing circuit for reading and writing operations.

10. A voice signal processing method, comprising:
sequentially receiving first voice data and second voice data, and storing a same in a first memory;
reading the first voice data from the first memory, and generating a control signal when the first voice data comprises a predetermined command;
reading the second voice data from the first memory according to the control signal, and storing the read second voice data in a second memory; and
reading the second voice data from the second memory according to the control signal to perform voice recognition.

11. The voice signal processing method according to claim 10, performed by a voice control device provided in a television or in a set-top box (STB).

12. The voice signal processing method according to claim 10, wherein the predetermined command is a first predetermined command, the control signal is a first control signal, and the voice signal processing method further comprises:
generating a second control signal to the memory control circuit and the main processing circuit when the first voice data comprises a second predetermined command.

13. The voice signal processing method according to claim 10, performed by a voice control device, wherein the step of reading the second voice data from the first memory according the control signal and storing the read second voice data in the second memory is performed by a memory control circuit, the step of reading the second voice data from the second memory according to the control signal to perform voice recognition is performed by a main processing circuit, and the voice processing method further comprises:
controlling the memory control circuit and the main processing circuit to be in a hibernation state when the voice control device is in an idle state; and
generating a wakeup signal to wake up the memory control circuit and the main processing circuit when the first voice data comprises the predetermined command.

14. The voice signal processing method according to claim 13, wherein the step of reading the first voice data from the first memory and generating the wakeup signal when the first voice data comprises the predetermined command is performed by a voice processing circuit, and the voice signal processing method further comprises:
after the voice processing circuit generates the wakeup signal to wake up the memory control circuit and the main processing circuit, the voice processing circuit not reading the second voice data from the first memory.

15. The voice signal processing method according to claim 13, wherein the step of reading the first voice data from the first memory and generating the wakeup signal when the first voice data comprises the predetermined command is performed by a voice processing circuit, and the voice processing method further comprises:
after the voice processing circuit generates the wakeup signal to wake up the memory control circuit and the main processing circuit, using the voice processing circuit to generate the control signal to control the memory control circuit to transfer the second voice data in the first memory to the second memory.

16. The voice signal processing method according to claim 10, further comprising:
setting access permission of at least one of the first memory and the second memory.

17. The voice signal processing method according to claim 16, performed by a voice control device, wherein the step of setting the access permission of the first memory or the second memory comprises:
setting an area in the first memory as a security area, and the receiving circuit storing the first voice data and the second voice data in the security area, which is permitted to be accessed only by an element in the voice control device.

18. The voice signal processing method according to claim 16, performed by a voice control device, wherein the step of setting the access permission of the first memory or the second memory comprises:
setting an area in the second memory as a security area, which is permitted to be accessed only by an element in the voice control device.
